(19) United States
(12) Patent Application Publication
(10) Pub. No.: US 2010/0095233 A1
(43) Pub. Date: Apr. 15, 2010

(54) DEVICE, SYSTEM AND COMPUTER IMPLEMENTED METHOD TO DISPLAY AND PROCESS TECHNICAL DATA FOR A DEVICE IN AN INDUSTRIAL CONTROL SYSTEM

(76) Inventors: Charlotte Skourup, Drammen (NO); Siri Breen, Oslo (NO); John Pretlove, Sandvika (NO); Jon Olav Eikenes, Oslo (NO)

Correspondence Address: VENABLE LLP, P.O. BOX 34385, WASHINGTON, DC, 20043-9998, US

(21) Appl. No.: 12/445,126

(22) PCT Filed: Aug. 3, 2007
(86) PCT No.: PCT/EP07/58082

§ 371 Date: Dec. 29, 2009

Related U.S. Application Data
(60) Provisional application No. 60/851,298, filed on Oct. 13, 2006.

(51) Int. Cl. G06F 3/048; G06F 3/033; G06F 3/041

(52) U.S. Cl. 715/771; 715/702; 345/161; 345/173; 715/856

(57) ABSTRACT

A method, device and system to retrieve and display technical data for an industrial device supervised by a computer program for control, configuration or condition monitoring in an industrial or commercial plant. In particular to use of a display member to provide a graphical user interface for manipulating data for, and/or for controlling, one or more industrial devices. A computing device or mobile computing device can send a link or reference of an application, interface or document to the display so that various applications interfaces may be displayed by the display for ease of information retrieval, manipulation and access.

A device, system and computer implemented method to display and process technical data for a device in an industrial control system.

### TECHNICAL FIELD

The invention concerns a method to display, present and manipulate technical data of one or more industrial devices using a computer program for control, configuration or condition monitoring for one or more devices in an industrial or commercial plant. The invention relates in particular to a method of using an active display device to provide an improved Human Machine Interface in the form of a graphical user interface suitable for more than one person to use and/or collaborate with other persons for the purposes of controlling, simulating, testing or for retrieving data about one or more industrial devices.

### TECHNICAL BACKGROUND

In control room environments, and other environments requiring task collaboration (both onsite and remote), people have a need for a common (physical) place for presenting and sharing information as well as interacting with information. Most of today's control room have conventional large screens for presenting information overview but the operators cannot actively interact with such information presented at the large screen.

A common problem is that all people involved in solving a problem, making a decision or planning need to be able to access information in addition to interacting with information. The situation is improved when people can discuss a sketch, drawing or a computer visualisation representing a problem or the background of a problem. In control rooms, the problems to be solved may typically be too complex to be sketched by hand. Control room operators use overviews and detailed information about the process and the current situation.

However today's information presentation means provide limited support for collaboration. Desktop monitors are limited in size both regarding the amount of information to be presented and the number of people who can look at such a screen. Large screens generally only allow limited interaction, if any interaction at all.

A typical example of a general collaboration situation is taken from the office environment where two or more people work together, e.g., on defining work packages and tasks for a project plan.

In the area of industrial process control, an international application WO 2005/114368 describes a method to manipulate data for an industrial device supervised by a control system in an industrial or commercial plant. A substantially static and easily visible large sized display member 2 is used to provide a graphical user interface for retrieving data about, and/or controlling, one or more industrial devices. The application also describes that a computing device or mobile computing device such as a PDA can send a link or URL to its GUI, or a copy of its GUI, to the large display for ease of information retrieval and access.

### SUMMARY OF THE INVENTION

A primary aim of the present invention is to provide a method to control or monitor an industrial device using an improved Graphical User Interface to retrieve and display technical data for the industrial device using a computer program for control and at least one computing device running said control program at least in part, wherein said control program comprises a graphical user interface arranged capable of generating a signal to retrieve said technical data related to one or more industrial devices.

A secondary aim is to provide a system for carrying out the method, and a computer program for carrying out the method. Another aim of the invention is to provide more than one instance of a graphical user interface (GUI) for carrying out the method.

The above and more objects are achieved according to the invention by a method according independent claim 1 and a system according to independent claim 20. Preferred embodiments are described in the dependent claims.

According to a first aspect of the invention these and more aims are met by the invention in the form of a method carried out by one or more computer programs running at least in part on the computing device that enable a copy of the graphical user interface running on the computing device to be displayed on a large display screen, and data retrieved and/or manipulated by means of actions carried out in relation to the GUI displayed on the large display screen.

According to another aspect of the invention these aims are met by the invention in the form of a system.

According to another aspect of the invention an active display device arranged with an improved input device is described.

In a preferred embodiment, the active display device is arranged for cooperation with wireless communication and wireless devices.

In one aspect of the invention an improved active display device in the form of a flat and horizontal screen, arranged for example as a touch-screen, is arranged and set up as a table. An interactive table, or touch table, it is dimensioned to allow a number of people to stand or sit around it. Each participant has his own ‘home’ area in front of him on the table where personal documents and applications of the person appear. This ‘home’ area may follow the participant as the participant moves around to different parts or sides of the table. Interaction with the interactive collaboration table takes place directly as a touch screen with hands and/or with specific interaction devices. The invention was disclosed at least in part in a provisional patent application U.S. 60/851,298 filed 13 Oct. 2006, which specification is hereby incorporated in this description in full by means of this reference.

The touch table allows multiple users to interact simultaneously either on different applications/documents or at the same application/document. Each collaborator can ‘drag’ a document/application from his ‘home’ area to the main area. The interactive touch table allows basic graphic interface manipulation actions such as to move, rotate, scale, crop and zoom the interface or window of an application or of a document.

Furthermore, the content of an application or a document can be edited such as to change a set point or to acknowledge an alarm. It is important that the system identifies the person who performs such a task. The interactive touch table is particularly advantageous to use for collaboration where an application or a document, etc. is critical for the discussions and the collaboration.

The advantages include that the interactive table: is a multiple user system; has support for simultaneously multiple inputs; can be operated for natural and intuitive collaboration; every participant can contribute equally; it supports carrying out online modifications by logged on users; it supports giving information in a number of different ways (eg direct writing of text and numbers (handwritten), as well as by selecting in ‘scroll-bars’, etc.).

The invention provides a user such as an operator or an engineer with means to take a copy of display a GUI, application interface or document that may be running on a first computer, and transfer it to the interactive table for easier manipulation of the GUI, collaboration with others and for easier access to information retrievable via the GUI. Instead of examining information and/or images on a small display screen, such as a 16″ monitor or a PDA display, the user may examine information displayed on a large screen. The user may also discuss the information and/or images of a selected industrial device with other operators or engineers so as to obtain information about the equipment, solve a problem, arrange for production processes, different production batches or versions etc, maintenance for one or more devices, and so on.

The principal advantage of the invention is that technical data and other information pertaining to a selected device may be quickly and easily retrieved and displayed and manipulated. This makes testing, trouble shooting, and general supervision and/or control of selected industrial devices, automation devices, robots, power distribution devices, to be carried out in a timely manner. This has the effect of reducing both predictable delays such as production set-up times, machine configuration or planned maintenance as well as downtime due to unpredicted stoppages, problems and the like.

In a preferred embodiment of the invention the computing device comprises one or more microprocessor units or computers. The computers or servers comprise memory means for storing one or more computer programs that control the graphical user interface of the interactive table. Preferably a such computer program contains instructions for the processor to perform the method as mentioned above and described in more detail below. In one embodiment the computer program is provided on a computer readable medium or data carrier such as a CD ROM.

### BRIEF DESCRIPTION OF THE DRAWINGS

Embodiments of the invention will now be described, by way of example only, with particular reference to the accompanying drawings in which:

FIG. 1 is a schematic or block diagram showing a layout in an industrial installation with an active display device according to an embodiment of the invention;

FIG. 2 is a schematic diagram of an input device for the active display device according to an embodiment of the invention;

FIG. 3a-c are flowcharts for one or more methods according to embodiments of the invention;

FIG. 4 is a schematic or block diagram of a display and application according to another aspect of the invention;

FIGS. 5 and 6 are screenshots showing views of the active display device and an application used in conjunction with the device according to a preferred embodiment of the invention;

FIGS. 7-10 are screenshots showing views of manipulating applications, interfaces or documents using the active display device according to a preferred embodiment of the invention;

FIGS. 11-12 are screenshots showing transfer to another user or movement to other user of applications, interfaces or documents using the active display device;

FIGS. 13-17 are screenshots showing manipulations of applications, interfaces or documents using the active display device according to an embodiment of the invention.

### DETAILED DESCRIPTION OF THE EMBODIMENTS

A user such as an operator, engineer or technician in a factory or other installation for industrial or commercial operations wishes to retrieve and/or manipulate information about an industrial device. The user may have already activated one or more control programs of an industrial control system so as to display a part of the installation including the industrial device of interest.

According to an embodiment of the present invention, one or more programs, applications, interfaces or documents showing or handling the industrial device of interest may be selected and marked in some way, preferably by dragging a representation on a graphic user interface to a graphic device hereafter called a “widget” which acts as a basket or other container.

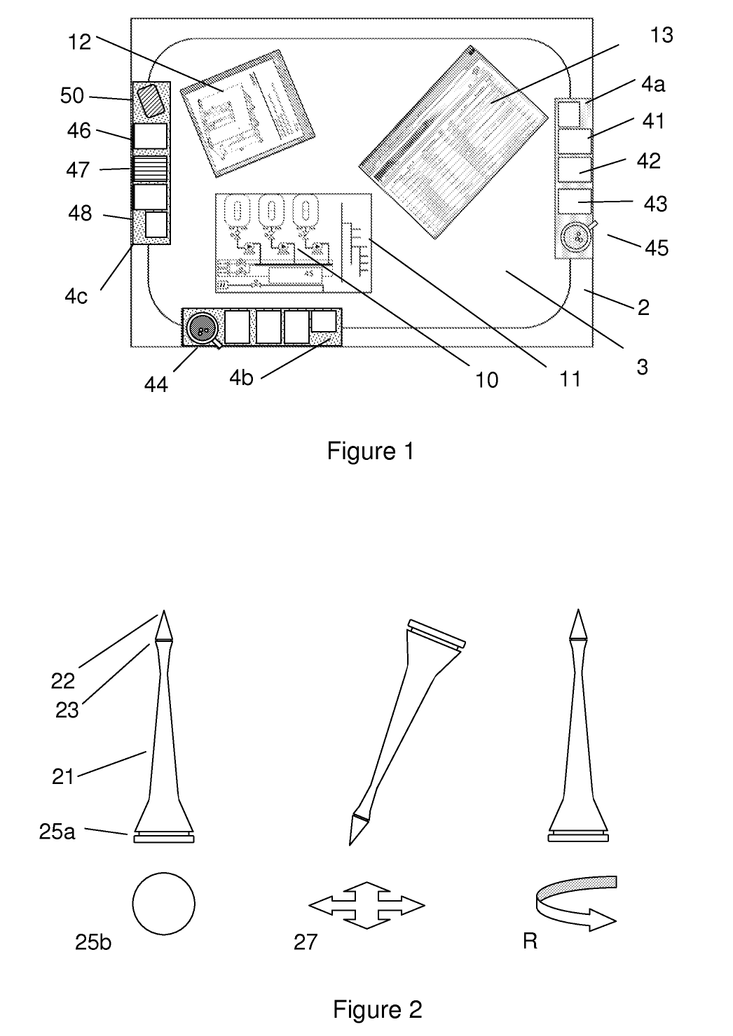

The user then goes to the active display device, the interactive table carrying with him or her an identification means. FIG. 1 shows the active display device, an interactive table. The figure shows a large horizontally arranged table 2 with an active display screen area 3. On some parts of the table one or more home areas 4a, 4b, 4c are arranged. Home area 4a displays programs or applications 41-43 that the user has pre-selected for use on the interactive table. On Home area 4a the user is identified by an object arranged with, for example, an RFID tag (RadioFrequency Identification tag), which in this case is attached to the user's coffee mug 45. Likewise the items arranged at Home area 4b. In Home area 4c, the user has laid down an ID card 50 which is identified by the system as belonging to the user. At 4c, the user has also pre-selected various programs or applications or documents 46-48.

FIG. 4 shows in a simplified diagram a display from a user workstation. The figure shows a display screen 15 with a graphic object 16 representing a transfer program called the “widget”. The user drags selected programs, applications, interfaces and/or documents 17-19 on to the widget. Then the user goes to the interactive table. As the user approaches the interactive table, a wireless device or ID object carried by the user is recognised by a wireless device in the vicinity of the interactive table, and he or her is then recognised by their ID. This causes the widget 16 and the pre-selected applications etc 17-19 to appear on the nearest Home area to the user on the interactive table 2 (FIG. 1). This transfer may be carried out by sending a link or reference of an application, interface or document from a computing device, or mobile computing device such as a PDA, to the large active display 3 so that various applications interfaces etc may be displayed by the large active display for ease of information retrieval, manipulation and access.

FIG. 1 shows the interactive table 2 to be displaying on the active display area 3 some two applications or interfaces 10, 13 and a document 12. The display 11 is a tree or object structure diagram associated with the process diagram 10 such that parts of the process diagram may have links to the control system objects that are used to control and monitor real world objects in the industrial control system.

FIG. 2 shows an input device for the interactive table. The figure shows a type of stylus or pointing object that is held by a user in the hand. The stylus 21 has a tip 22 and may have a built-in switch 23 to provide a signaling, switching or selection function associated with the tip position. The base 25a is round as indicated by the view 25b. The stylus may be arranged with a second built-in switch 24 to provide a selection, signaling or switching function when the base 25a of the stylus is being operated. The point of the stylus may be moved in any direct on the surface of the table 2, as indicated by multi-arrow 27. When the base of the stylus is used to mark or select on the display, the base may also be rotated in a direction as indicated by arrow R.

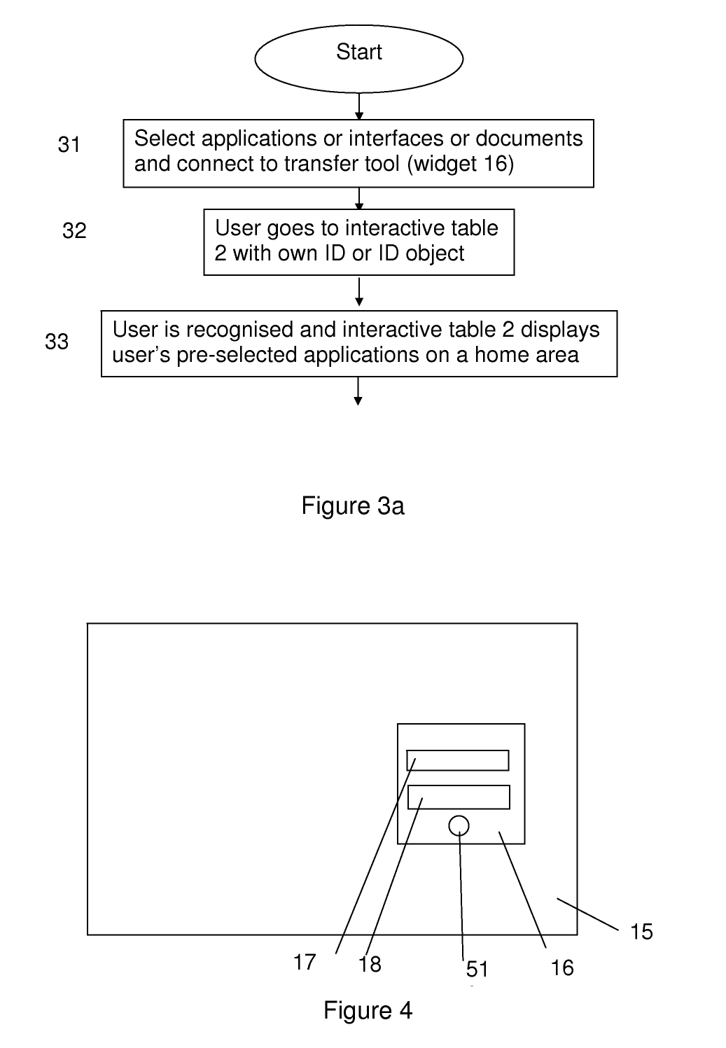

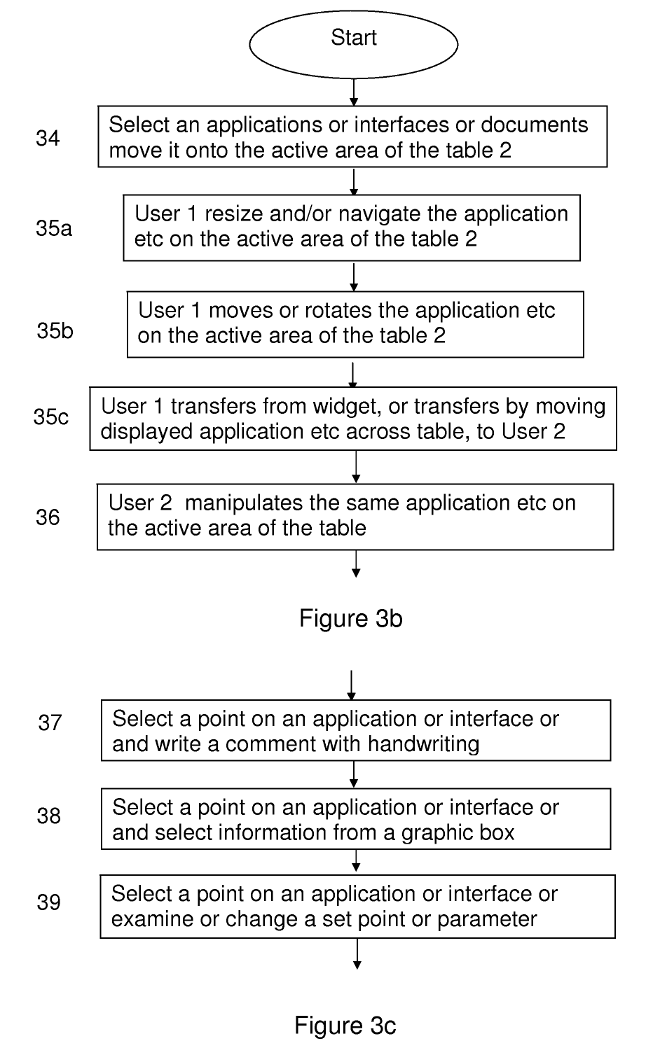

FIG. 3a shows a flowchart for at least one method of an embodiment of the invention. A user selects one or more applications or interfaces or documents associated with an industrial device or process by, for example, dragging them on to the tool called the widget. The method comprises:
Select applications or interfaces or documents and connect to transfer tool (widget 16)
User goes to interactive table 2 with own ID or ID object
User is recognised and interactive table 2 displays user's pre-selected applications on a home area.

The table recognises the User ID card 50 or object 45 and displays on a home area 4a-4c the ID object and the widget. The user may then move or open an application etc on the interactive table.

FIG. 3b shows a flowchart for another part of a method according to an embodiment of the invention. A user at the interactive table may select one of the applications etc and move or open it on the table. The application or interface or document displayed may be resized, rotated etc. The method comprises:
Select an applications or interfaces or documents move it onto the active area of the table 2
User 1 resize and/or navigate the application etc on the active area of the table 2
User 1 moves or rotates the application etc on the active area of the table 2
User 1 transfers from widget, or transfers by moving displayed application etc across table, to User 2-
User 2 manipulates the same application etc on the active area of the table

Thus more than one user may manipulate an application on the interactive table. More than one user may manipulate the same application or interface at the same time.

FIG. 3c shows a flowchart for another part of a method according to an embodiment of the invention. A user may select a part of an interface, or a graphic object on the interface, and input a value from a scroll box or other selection means. Input may also be done by writing freestyle. Set points or other parameters may be selected and changed. Input is made via the active display means by a signal transmitted by any of IR, wireless radio, ultra sound. The pointing device or stylus 21 may have all the graphic interface functionality that a computer mouse usually has to operate graphic functions, cut, copy, paste, re-size and so on.

The method comprises:
Select a point on an application or interface or and write a comment with handwriting
Select a point on an application or interface or and select information from a graphic box
Select a point on an application or interface or examine or change a set point or parameter

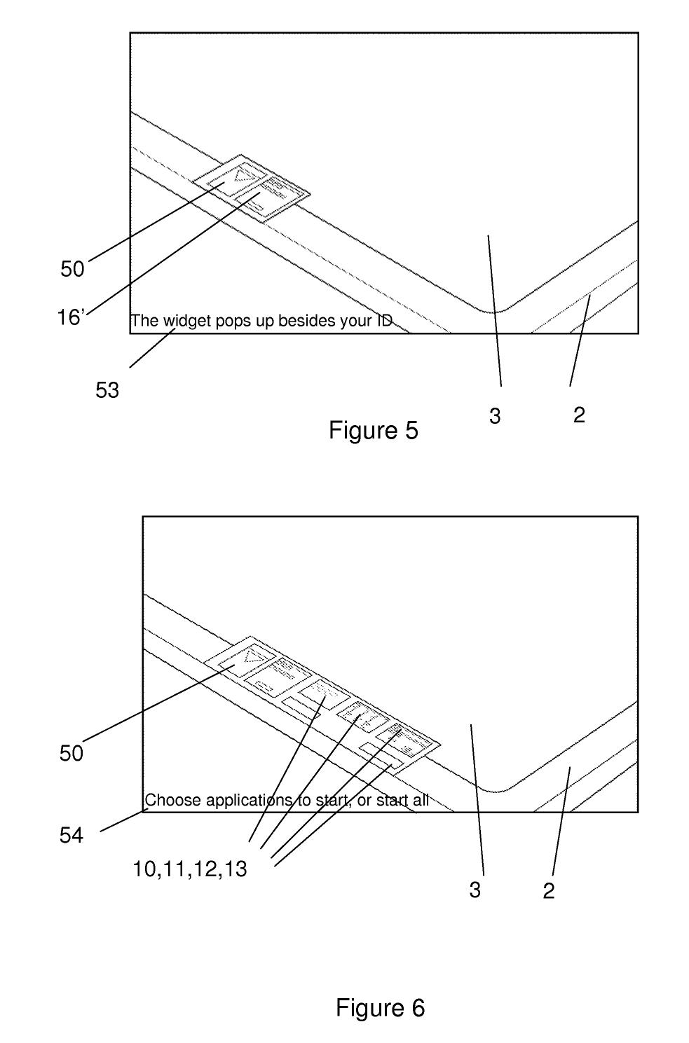

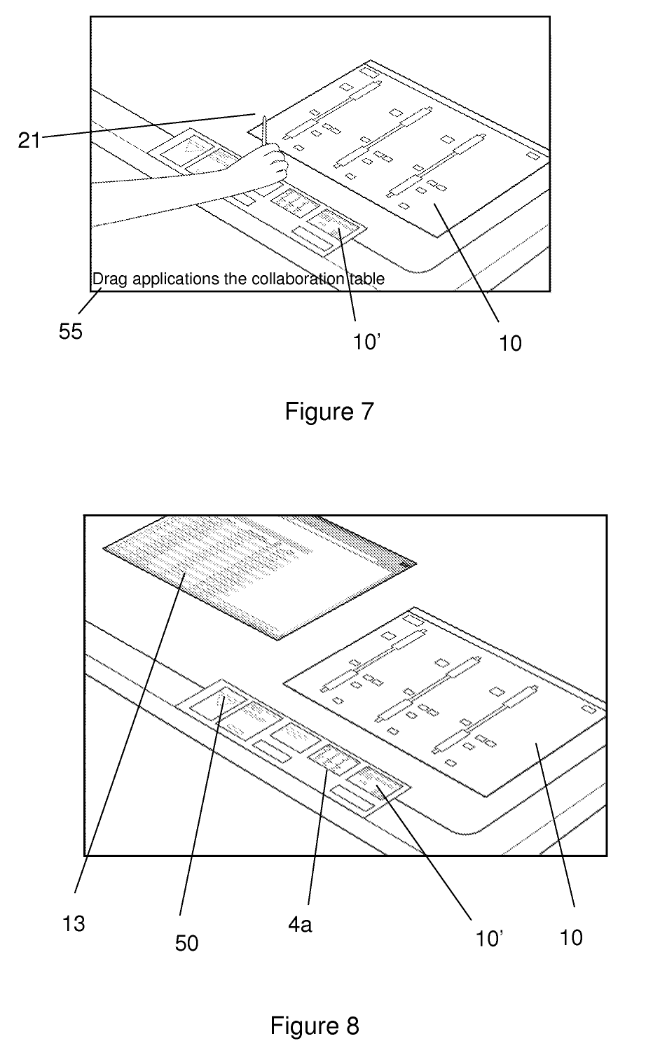

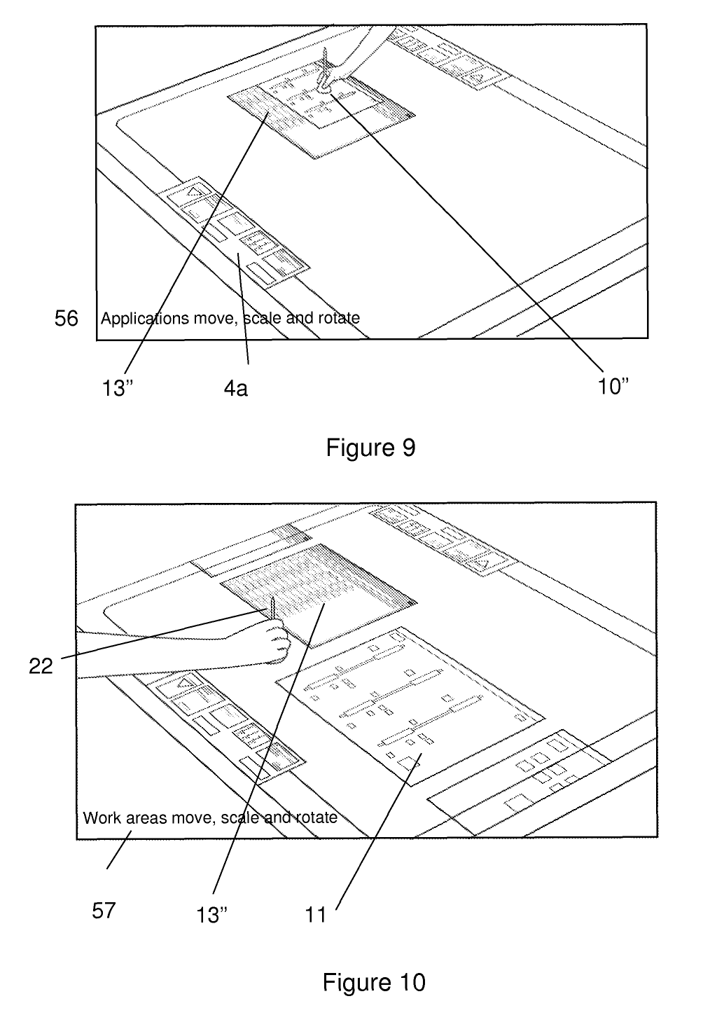

FIG. 5 shows the interactive table 2 with the active display and touch sensitive area 3. A home area is shown with an ID object 50 (card) and a display of the widget 16′. The legend reads 53 the widget pops up besides your ID. FIG. 6 shows the ID card 50 on the home area, and the applications 10-13 that are transferred by the widget 16′, and the legend 54 reads Choose applications to start, or start all. In FIG. 7 an application or interface 10 is dragged onto the table from its representation or icon 10′ provided by the widget 16′. The legend 55 reads drag applications to the collaboration table. FIG. 8 shows another application or interface 13 dragged on to the table. Once open on the interactive table FIGS. 9 and 10 show the applications being scaled and moved and also being re-sized or rotated.

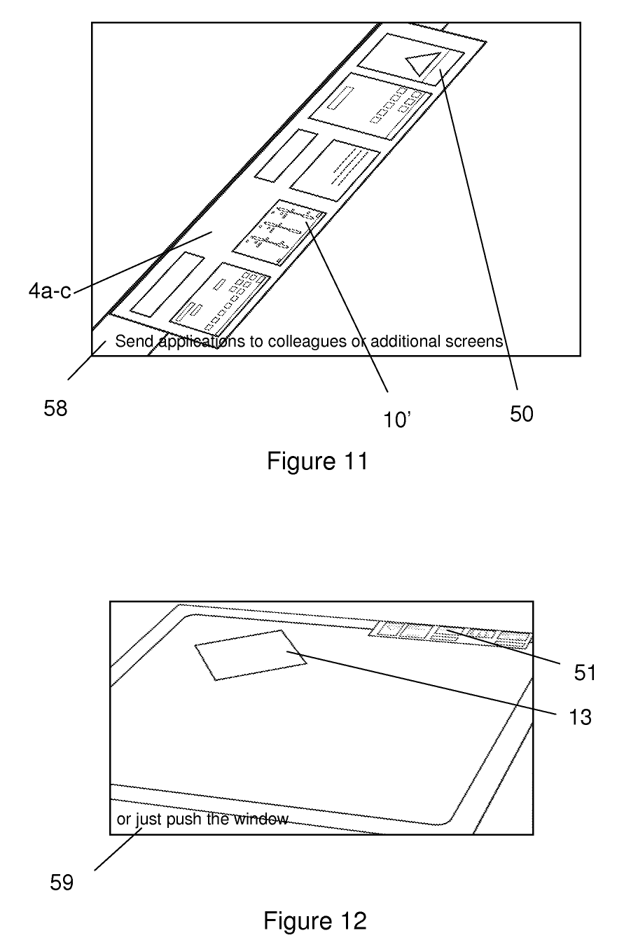

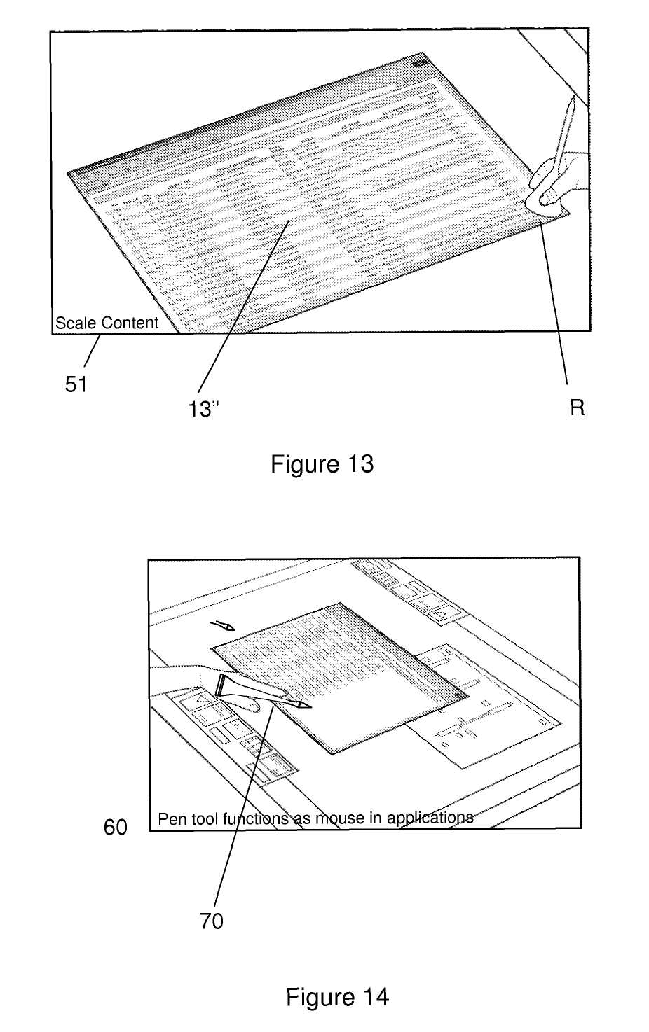

FIG. 11 shows that the home area may be used to send applications from the widget to another user, either on the interactive table or to another display at another location. FIG. 12 shows that an application or document may be graphically pushed across the table to another use by an action with the pointing device. Users may also use movements of their hands instead of the pointing device or stylus to signal some of the commands. For example, a movement or an action by a user on or close to the table or active display device surface may be determined by means of an inertial sensor. FIG. 13 shows a scaled-up clip from a window and FIG. 13 shows the stylus or pen being used to carry out selection, copy, re-size etc commands that a computer muse may do.

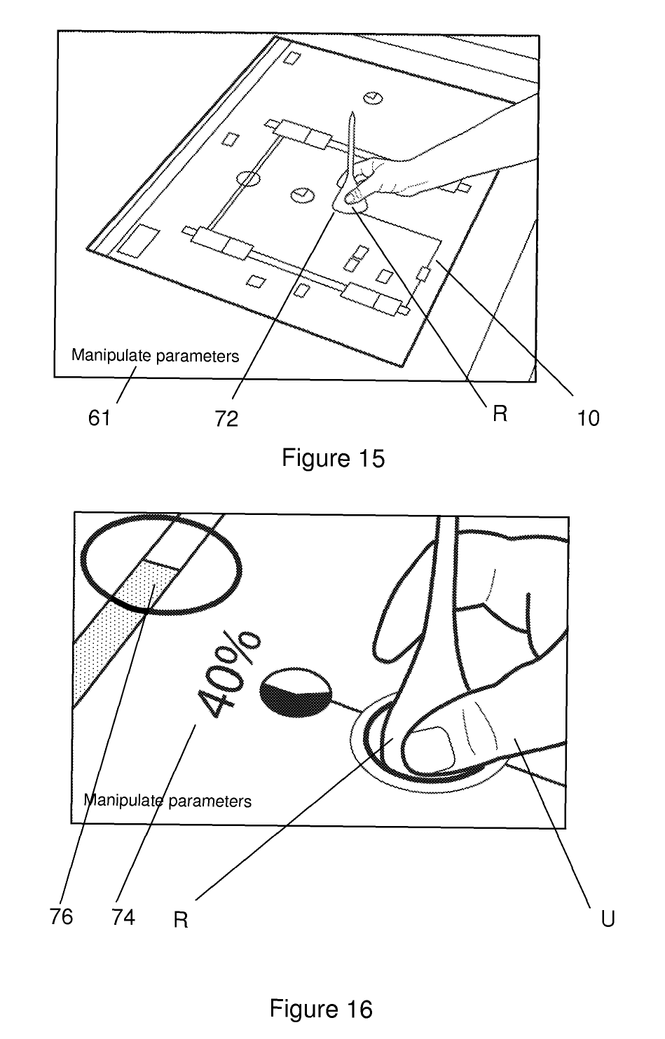

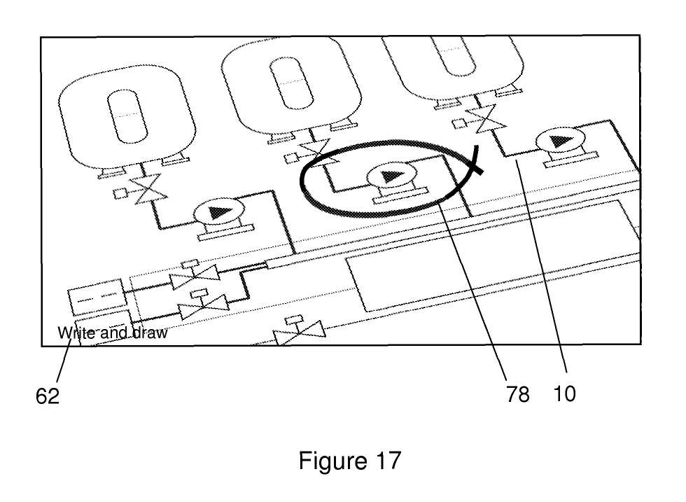

FIG. 15 shows a parameter 72 selected on a process display 10 and the stylus is rotated R by the user holding it to vary a parameter value. Similarly in FIG. 16 the stylus is rotated R by the user U and a parameter 74 is changed; also another graphic display 76 of that parameter changes. FIG. 17 illustrates that the stylus or other pointing device may be used to write or draw 78 freehand on an application or process display 10. The majority of industrial devices of the installation are normally in some way all under the supervision of one or more computer programs for monitoring and/or control. The one or more control programs contain technical data and/or links to technical data and other information for each industrial device. By manipulating the interactive display device GUI 3 the user may select all or any such information relevant to the chosen industrial device, or a process or equipment that it is a part of, and retrieve such relevant stored parameters, variables, set-points, logged values as the user decides. This information may be in any form, such as numbers, stored values, real-time values, text, tables, trends, graphs, pie-charts and so on. Drawings or CAD drawings of equipment construction or parts may also be retrieved and displayed large scale on the large screen so that the user and others may easily retrieve and access, see and discuss or otherwise use information about the industrial device.

In another preferred embodiment, the program for control of processes and industrial devices in a facility may use representations other than tree diagrams to symbolise facets of the equipment controlled. Equipment and or devices may be represented in terms of process logic, in relational diagrams, process-flow diagrams, function block schemas, flow charts or any other way for representing industrial, chemical or commercial processes. The user may then use a tree structure or a process logic structure etc to navigate within and/or between devices and processes represented in the control program to retrieve technical data about a device or a process etc.

A data connection may be established at least at first by means of a wireless network or temporary wireless network, using for example a radio technology such as Bluetooth, or an IR connection to initiate recognition of the selected display screen (workstation) and/or recognition of the PDA user. Thereafter the methods and advantages are as described. Any workstation in a plant may be used, so long as there is means to identify the workstation, and any kind of computer controlled display device may be used, including a fixed workstation, portable computer or laptop, notebook etc or even suitably equipped telephone, provided that it is connected to a display that can provide a GUI.

Suitably low-energy transmissions compatible with explosion-proof standards for use, for example, by a painting robot, may be made using a short-range radio communication, such as a low-energy transmission conforming to a protocol compatible with any of: standards issued by the Bluetooth Special Interest Group (SIG); any variation of IEEE-802.11, WiFi, Ultra Wide Band (UWB), ZigBee or IEEE-802.15.4, IEEE-802.13 or equivalent or similar. A standard compatible with WAPI (WLAN Authentication and Privacy Infrastructure, GB15629.11-2003 or later) may advantageously be used in situations where encryption of the wireless signal is necessary or advantageous. Generally a radio technology working at high frequencies usually greater than 400 MHz, for example in the ISM band or higher, with significant interference suppression means by spread spectrum technology is the preferred type of wireless communication. Wireless communication may alternatively be carried out using Infra Red (IR) means and protocols such as IrDA, IrCOMM or similar. Wireless communication may also be carried out using sound or ultrasound transducers.

One or more microprocessors (or processors or computers) comprise a central processing unit CPU performing the steps of the methods according to one or more aspects of the invention, as described for example with reference to FIGS. 3a-3c. The method or methods are performed with the aid of one or more computer programs, which are stored at least in part in memory accessible by the one or more processors. It is to be understood that the computer programs for carrying out methods according to the invention may also be run on one or more general purpose industrial microprocessors or computers instead of one or more specially adapted computers or processors.

The computer program comprises computer program code elements or software code portions that make the computer or processor perform the methods using equations, algorithms, data, stored values, calculations and statistical or pattern recognition methods previously described, for example in relation to FIGS. 3a-3c. The computer program may include one or more small executable programs. A part of the program may be stored in a processor as above, but also in a ROM, RAM, PROM, EPROM or EEPROM chip or similar memory storage means or memory storage device. The or some of the programs in part or in whole may also be stored locally (or centrally) on, or in, other suitable computer readable medium such as a magnetic disk, CD-ROM or DVD disk, hard disk, magneto-optical memory storage means, in volatile memory, in flash memory, as firmware, or stored on one or more data servers. Other known and suitable media, including removable memory media such as Sony memory stick (TM) and other removable flash memories, hard drives etc. may also be used. The program may also in part be supplied from a data network, including a public network such as the Internet. The computer programs described may also be arranged in part as a distributed application capable of running on several different computers or computer systems at more or less the same time.

It should be noted that while the above describes exemplifying embodiments of the invention, there are several variations and modifications which may be made to the disclosed solution without departing from the scope of the present invention as defined in the appended claims.

1. A computer implemented method to retrieve and display technical data for an industrial device in an industrial control system including generating technical data for said industrial device and displaying the technical data utilizing an application interface displayed on an active display device arranged with input means, the method comprising:
displaying one or more application interfaces where at least one application interface provides a display of information about a said technical device, and
manipulating one or more application interfaces using said input utilizing said active display device at the same time.

2. The method according to claim 1, wherein at least a first user and a one second user manipulate at the same time any of one or more said application interfaces displayed on the active display device.

3. The method according to claim 1, further comprising:
selecting the one or more application interfaces.

4. The method according to claim 1, wherein control is passed from one user to another user by graphically moving said application across the active display device.

5. The method according to claim 1, wherein input to manipulate an application interface on the active display means device is made by determining a movement or an action by a user on or close to the active display device surface.

6. The method according to claim 1, wherein input to manipulate an application interface on the active display device is made by determining a touch action by a user on or close to the active display device surface.

7. The method according to claim 1, wherein input is made to an application, interface or document to carry out any from the group of: input to select an object on an interface; input to change or modify a value of an object on an interface; input to add an object, input to remove a graphic object, input to hide a graphic object or a text object.

8. The method according to claim 1, wherein input is made by means of with a hand held or moved on or close to the surface of the active display means device.

9. The method according to claim 5, wherein input to manipulate an application interface on the active display device is made by determining a movement or an action by a user on or close to the active display device surface by tracking position of a user hand or a pointer device.

10. The method according to claim 1, wherein input is made via a pointer device held or moved on or close to the surface of the active display device.

11. The method according to claim 1, wherein input is made via the active display device by a signal transmitted by any of IR, wireless radio, ultra sound, laser.

12. The method according to claim 1, wherein input is made via a activating one or more built-in switch of a hand-held device and/or a/the pointer device.

13. The method according to claim 1, wherein input or manipulation is done to carry out any from the group of a: test; a simulation, an optimisation, monitoring, configuration, fault-finding, design, engineering, system updates, maintenance, planning.

14. The method according to claim 1, further comprising:
transmitting a reference for user ID to an active display device.

15. The method according to claim 1, further comprising:
retrieving data associated with information represented by said graphical user interface and
providing the data to a computer or processor for display and manipulation on the active display device.

16. The method according to claim 1, further comprising:
selecting with said computing device a representation of an industrial device and marking it the representation, and
manipulating said graphical user interface causing the graphical user interface to send a reference to the representation of the marked industrial device to the separate display member.

17. The method according to claim 1, further comprising:
selecting with said computing device a representation of an industrial device and marking the digital representation, and
manipulating said graphical user interface causing the graphical user interface to send an executable or active link to the representation of the marked industrial device to the separate display member.

18. A computer program product, comprising:
a computer readable medium; and
software code elements recorded on the computer readable medium and executable by a computer or processor to cause the computer or processor to carry out a method to retrieve and display technical data for an industrial device in an industrial control system including generating technical data for said industrial device and displaying the technical data utilizing an application interface displayed on an active display device arranged with input means, the method comprising displaying one or more application interfaces where at least one application interface provides a display of information about a said technical device, and manipulating one or more application interfaces using said input utilizing said active display device at the same time.

19. (canceled)

20. A system for retrieval and display of technical data for an industrial device in an industrial control system including generating technical data for said industrial device and displaying the technical data utilizing an application interface displayed on an active display device arranged with input element, the system comprising:
an active display device for display and/or manipulation of the application interface to which said one or more industrial devices are connected.

21. The system according to claim 20, wherein the active display device comprises a graphical user interface arranged with interactive elements such that the active display device is a touch-sensitive screen.

22. The system according to claim 20, wherein the active display device comprises a graphical user interface arranged with interactive elements such that the active display device registers close proximity of a hand or other object.

23. The system according to claim 20, wherein it further comprising:
a member for transmitting and/or receiving wireless communication about User ID to and/or from the active display device.

24. The system according to claim 20, further comprising:
at least one input member for selecting, navigating and/or one or more of the application interfaces, or documents.

25. The system according to claim 20, further comprising:
an inertial sensor arranged for input to manipulate an application interface on the active display device by determining a movement or an action by a user on or close to the active display device surface.

26. The system according to claim 20, wherein the computing device comprises a portable computing device.

27. The system according to claim 20, further comprising:
wireless communication elements compatible with a wireless LAN.

28. The system according to claim 20, wherein the active display device comprises a wireless member for detecting movement and position using any element from the list of: ultrasonic sound, infra red light, visible light.

29. The system according to claim 20, wherein the active display device may comprise a directional input member comprising any from the list of: button, joystick, ball, mouse, stylus, touch surface, elastic directional input member.

30. The system according to claim 20, further comprising one or more computer program products comprising a computer readable medium, and software code elements recorded on the computer readable medium and executable by a computer or processor to cause the computer or processor to carry out a method to retrieve and display technical data for an industrial device in an industrial control system including generating technical data for said industrial device and displaying the technical data utilizing an application interface displayed on an active display device arranged with input means, the method comprising displaying one or more application interfaces where at least one application interface provides a display of information about a said technical device, and manipulating one or more application interfaces using said input utilizing said active display device at the same time.

31. A graphical user interface of an active display device for retrieving and displaying technical data for an industrial device in an industrial control system including generating technical data for said industrial device and displaying the technical data utilizing an application interface displayed on the active display device which is arranged with input elements, the graphical user interface comprising:
at least one graphical representation member for carrying out a method to retrieve and display technical data for an industrial device in an industrial control system including generating technical data for said industrial device and displaying the technical data utilizing an application interface displayed on an active display device arranged with input means, the method comprising displaying one or more application interfaces where at least one application interface provides a display of information about a said technical device, and manipulating one or more application interfaces using said input utilizing said active display device at the same time.

32. The system according to claim 20, wherein the application interface permits carrying out any from the group of: checking a status of an industrial device, engineering an industrial device, making a change to a set point or control parameter for an industrial device, configuring an automation device, controlling an automation device, tuning a process, checking a process variable, teaching a robot, editing a robot program.
